(19) United States
(12) Patent Application Publication
(10) Pub. No.: US 2026/0281541 A1
(43) Pub. Date: Sep. 17, 2026

(54) IMAGE PROCESSING APPARATUS AND IMAGE PROCESSING METHOD

(71) Applicant: CANON KABUSHIKI KAISHA, Tokyo (JP)

(72) Inventor: Yukiko KUBO, Kanagawa (JP)

(21) Appl. No.: 19/466,605

(22) Filed: Feb. 2, 2026

(30) Foreign Application Priority Data
Feb. 12, 2025 (JP) 2025-020987

(51) Int. Cl. H04N 23/60; G06T 11/60; H04N 23/56; H04N 23/81

(52) U.S. Cl. CPC H04N 23/64; G06T 11/60; H04N 23/56; H04N 23/81

(57) ABSTRACT

An image processing apparatus displays a virtual space image on a display apparatus provided in a real space, and generates, for a reflection region where a specific reflection occurs on a subject in an image acquired by capturing an image of the subject in the real space and the virtual space image displayed on the display, a reflection image corresponding to the reflection region based on a position of the reflection region, a position at which the image is captured, and the virtual space image.

### BACKGROUND

### Field of the Technology

The present disclosure relates to a virtual production system.

### Description of the Related Art

Visual Effects (VFX) are techniques of compositing computer graphics (CG) into actually captured live-action visuals. In-camera Visual Effects (in-camera VFX) are techniques of displaying a virtual space image of CG and capturing an image of a subject in a real space with the virtual space image as a background in visual content production for a movie or the like. In in-camera VFX, light from a surrounding object, light source, or the like is reflected on a glossy subject such as a car or motorcycle, and an incorrect image or an unnatural image may be reflected on the captured subject. In contrast, in virtual production, by displaying the virtual space image of CG on a background image screen called an LED wall and capturing an image of a subject in the real space with the virtual space image as a background, it is possible to reproduce a desired reflection for a region where a specific reflection such as incorrect the image or the unnatural image occurs.

As a method of generating such reflection image, Japanese Patent Laid-Open No. 2011-164184 describes a method of generating, by ray tracing processing, an image in which a background image is reflected on the surface of a subject. In addition, Japanese Patent Laid-Open No. 2019-056997 describes a method of generating an image in which a scene in front of the user is reflected on the eye region of the user by compositing an image of the scene in front of the user, which is captured by an out-camera, into the eye region of the user captured by an in-camera.

However, in virtual production, in a case where the LED wall cannot be used, a case where the display range of the LED wall is narrow, a case where the illumination light is used, or the like, light from a surrounding object, light source, or the like other than the background image may be reflected on a subject, and it may be impossible to reproduce a desired reflection.

Furthermore, according to Japanese Patent Laid-Open No. 2011-164184, when capturing an image of a subject in the real space with 3D CG as a background, the light source of an actual scene cannot be considered. According to Japanese Patent Laid-Open No. 2019-056997, a camera for capturing an image of a subject and a camera for performing image capture to generate a reflection image are necessary.

### SUMMARY

The present disclosure has been made in consideration of the aforementioned problems, and provides technical advantages that it is possible to generate a desired reflection image using a virtual space image for a region where a specific reflection occurs on a subject as an image capture target.

In order to solve the aforementioned problems, the present disclosure is directed to an image processing apparatus comprising: at least one processor; and at least one memory which stores a program which, when executed by the at least one processor, causes the image processing apparatus to function as: a display control unit that displays a virtual space image on a display apparatus provided in a real space; and a generation unit that generates, for a reflection region where a specific reflection occurs on a subject in an image acquired by capturing an image of the subject in the real space and the virtual space image displayed on the display apparatus, a reflection image corresponding to the reflection region based on a position of the reflection region, a position at which the image is captured, and the virtual space image.

According to the present disclosure, it is possible to generate a desired reflection image using a virtual space image for a region where a specific reflection occurs on a subject as an image capture target.

Features of the present disclosure will become apparent from the following description of embodiments with reference to the attached drawings. The following description of embodiments is given by way of example.

### BRIEF DESCRIPTION OF THE DRAWINGS

The accompanying drawings, which are incorporated in and constitute a part of the specification, illustrate embodiments of the present disclosure, and together with the description, serve to explain the principles of the embodiments.

FIG. 1 is a view showing a system configuration according to the present embodiment;

FIG. 2 is a block diagram exemplifying an apparatus configuration according to the present embodiment;

FIG. 3 is a flowchart exemplifying control processing according to the present embodiment;

FIG. 4 is a flowchart exemplifying reflection region detection processing according to the present embodiment;

FIG. 5 is a flowchart exemplifying reflection image generation processing according to the present embodiment;

FIG. 6 is a graph exemplifying the reflectance of a reflection region according to the present embodiment; and

FIG. 7 is a flowchart exemplifying reflection removal processing according to the present embodiment.

### DESCRIPTION OF THE EMBODIMENTS

Hereinafter, embodiments will be described in detail with reference to the attached drawings. Note, the following embodiments are not intended to limit the scope of the claims. Multiple features are described in the embodiments, but it is not the case that all such features are required, and multiple such features may be combined as appropriate. Furthermore, in the attached drawings, the same reference numerals are given to the same or similar configurations, and redundant description thereof is omitted.

### <System Configuration>

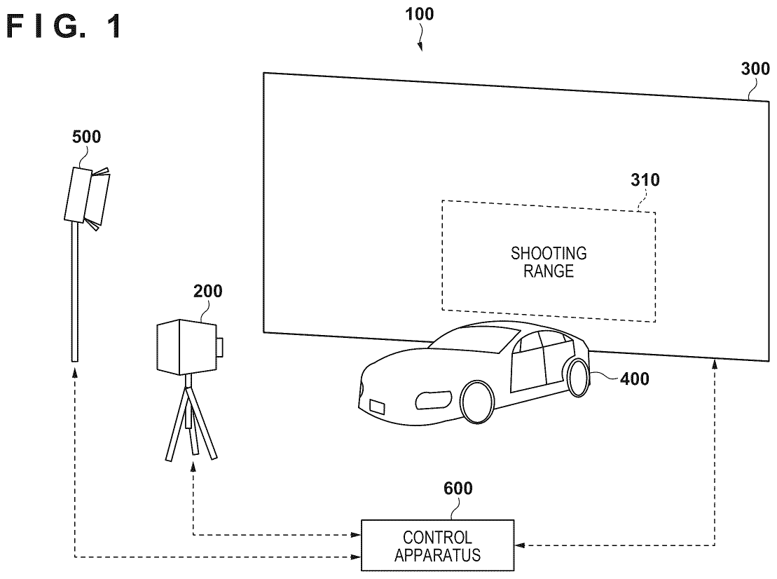

A virtual production system according to the present embodiment will be described first with reference to FIG. 1. In the present embodiment, the term “image (image data)” is used with the intention of including both video (video data) and still image (still image data).

A virtual production system (to be referred to as a system hereinafter) 100 according to the present embodiment includes an image capture apparatus 200, a display apparatus 300, a lighting apparatus 500, and a control apparatus 600. The image capture apparatus 200 generates an in-camera VFX image by capturing an image of a subject in the real space with, as a background, a virtual space image displayed on the large display apparatus 300 called an LED wall. An example of the subject in the real space is a glossy subject (to be referred to as a subject as an image capture target hereinafter) 400 such as a car or motorcycle on which the background may be reflected. An image capture range 310 in the display apparatus 300 is a region corresponding to the image capture angle of the image capture apparatus 200.

The system 100 according to the present embodiment generates a desired reflection image for replacing, by images and videos such as a natural reflection, a reflection region where an incorrect reflection or an unnatural reflection (to be referred to as a specific reflection hereinafter) occurs on the subject 400 as an image capture target during the image capture of the in-camera VFX image.

A case where a specific reflection occurs in virtual production is a case where a reflection different from a desired reflection occurs, such as a case where the background to be reflected is broken or a necessary region is not reflected due to a narrow display range of the LED wall or a case where illumination light is reflected when controlling the brightness of the illumination light on a person or the like.

With respect to the image capture apparatus 200, the display apparatus 300, and the lighting apparatus 500, the control apparatus 600 acquires information concerning an operation from each apparatus and controls the operation based on the information acquired from each apparatus. The control apparatus 600 renders a virtual space image associated in advance with a position in the real space in accordance with the image capture position (viewpoint position) of the image capture apparatus 200. Then, the control apparatus 600 adjusts a background image of CG generated by rendering in accordance with the image capture angle and direction of the image capture apparatus 200, and displays it in the image capture range 310 of the display apparatus 300. Information of the viewpoint position of the image capture apparatus 200 can be acquired by detecting a marker provided in the image capture apparatus 200 by a sensor arranged in the ceiling or the like. The present embodiment has explained an example of using a marker but another known method may be used.

The control apparatus 600 sends information concerning the lighting state of the lighting apparatus 500. The lighting state includes at least one of the presence/absence of lighting of a light source, an irradiation direction, a light emission intensity, and a color temperature. The lighting apparatus 500 performs the operation of the lighting apparatus 500 based on the information concerning the operation received from the control apparatus 600.

### <Apparatus Configuration>

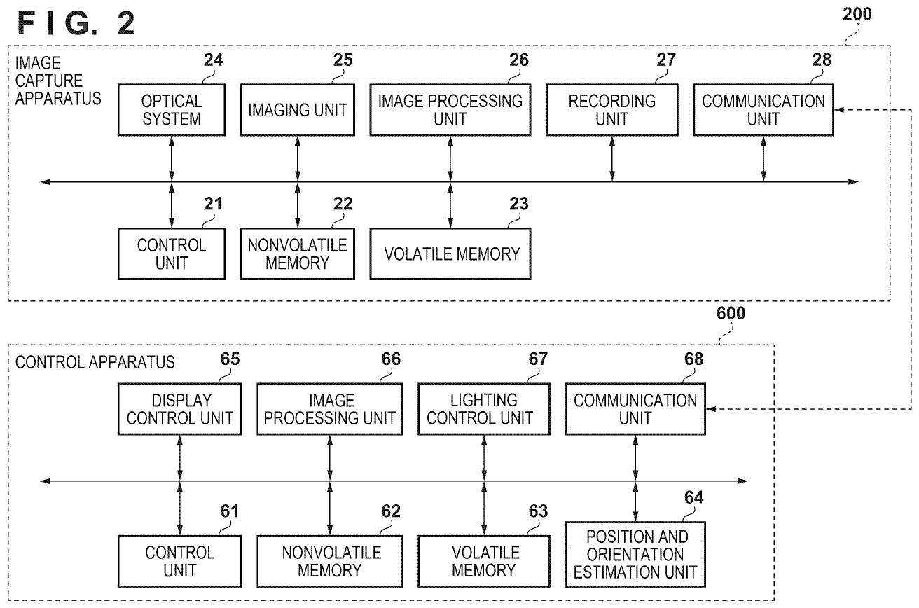

The configurations of the image capture apparatus 200 and the control apparatus 600 forming the system 100 according to the present embodiment will be described next with reference to FIG. 2.

First, the configuration and function of the image capture apparatus 200 according to the present embodiment will be described.

The image capture apparatus 200 according to the present embodiment is, for example, a digital camera or a digital video camera.

The function of the image capture apparatus 200 according to the present embodiment is implemented by the hardware shown in FIG. 1 and/or a software program executed by a control unit 21.

The control unit 21 is an arithmetic processor such as a CPU or an MPU that generally controls the entire image capture apparatus 200, and executes programs stored in a nonvolatile memory 22 to be described later, thereby implementing control processing to be described later. Note that instead of controlling the entire apparatus by the control unit 21, a plurality of hardware components may control the entire apparatus by sharing processing.

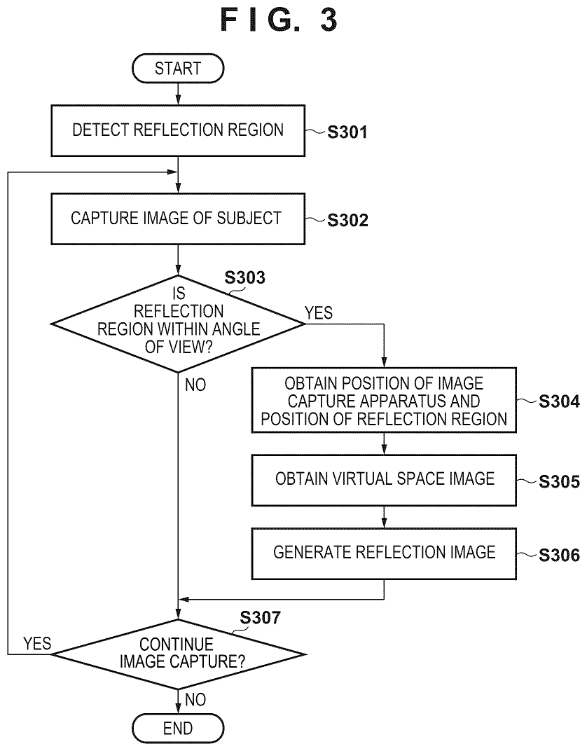

The nonvolatile memory 22 is a flash memory, a solid-state drive (SSD), a hard disk drive (HDD), or the like from/in which data can be removed/written. The nonvolatile memory 22 records constants for the operation of the control unit 21, programs, and the like. In the present embodiment, the programs are those for executing control processing to be described later with reference to FIG. 3.

A volatile memory 23 is a RAM that temporarily stores a program read out from the nonvolatile memory 22, constants and variables for executing the program, and the like. In addition, the volatile memory 23 is used as a work memory of the control unit 21 and an image processing unit 26 to be described later. The volatile memory 23 is used as a buffer memory that temporarily holds an image and video signal generated by an imaging unit 25 to be described later, and image data processed by the image processing unit 26.

An optical system 24 includes a lens group including a zoom lens and a focus lens, and a shutter having an aperture function.

The imaging unit 25 includes an image sensor formed by a CCD or CMOS element that converts a subject image into an electrical signal, and an A/D converter that converts an analog image and video signal output from the image sensor into a digital signal. Under the control of the control unit 21, the imaging unit 25 converts subject image light whose image is formed by the lenses included in the optical system 24 into an electrical signal by the image sensor, performs noise reduction processing or the like, and outputs a digital image and video signal. Note that the optical system 24 including the lens group and the shutter may be detachable from the image capture apparatus 200.

The image processing unit 26 includes a Graphics Processing Unit (GPU), and executes various kinds of image processes for the image and video signal generated by the imaging unit 25. The image processing unit 26 generates an image file or video file by compression-coding still image data having undergone the image processing by JPEG or the like, or by encoding video data by a video compression method such as MPEG2 or H.264, and records the file in a recording unit 27 such as a memory card. The image processing unit 26 performs predetermined arithmetic processing using the image and video signal generated by the imaging unit 25, and the control unit 21 controls the focus lens, the aperture, and the shutter of the optical system 24 based on the acquired arithmetic result, thereby performing Auto Focus (AF) processing or Auto Exposure (AE) processing. In addition, the image processing unit 26 generates the reflection image based on the position of the reflection region, the position of the image capture apparatus 200, and the virtual space image with respect to the image and video signal generated by the imaging unit 25, and records the reflection image in the volatile memory 23.

The recording unit 27 is a memory card detachable from the image capture apparatus 200, and records image data processed by the image processing unit 26 and recorded in the volatile memory 23.

A communication unit 28 is communicably connected to an external apparatus such as the control apparatus 600 via a wire or wirelessly, and exchanges information of data. The communication unit 28 receives the position of the reflection region, the position of the image capture apparatus 200, and the virtual space image from the control apparatus 600, and supplies them to the image processing unit 26. Next, the configuration and function of the control apparatus 600 according to the present embodiment will be described.

The control apparatus 600 according to the present embodiment is a general-purpose computer such as a personal computer (PC) or a tablet computer, or a dedicated computer such as a server computer.

The function of the control apparatus 600 according to the present embodiment is implemented by the hardware shown in FIG. 2 and/or a software program executed by a control unit 61. The control apparatus 600 controls the image capture apparatus 200, the display apparatus 300, and the lighting apparatus 500.

The control unit 61 is an arithmetic processor such as a CPU or an MPU that generally controls the entire control apparatus 600, and executes programs stored in a nonvolatile memory 62 to be described later, thereby implementing control processing to be described later. Note that instead of controlling the entire apparatus by the control unit 61, a plurality of hardware components may control the entire apparatus by sharing processing.

The nonvolatile memory 62 is a flash memory, a solid-state drive (SSD), a hard disk drive (HDD), or the like from/in which data can be removed/written. The nonvolatile memory 62 records constants for the operation of the control unit 61, programs, and the like. In the present embodiment, the programs are those for executing control processing to be described later with reference to FIG. 3.

A volatile memory 63 is a RAM that temporarily stores a program read out from the nonvolatile memory 62, constants and variables for executing the program, and the like. In addition, the volatile memory 63 is used as a work memory of the control unit 61 and an image processing unit 66 to be described later. The volatile memory 63 is used as a buffer memory that temporarily holds image data received from the image capture apparatus 200, image data processed by the image processing unit 66, and the like.

A position and orientation estimation unit 64 acquires position information of the image capture apparatus 200. The position information of the image capture apparatus 200 is detected by, for example, capturing an image of a marker arranged on the ceiling by the image capture apparatus 200. In addition, the position and orientation estimation unit 64 detects the orientation by estimating the angle of view of the image capture apparatus 200 based on the image data acquired from the image capture apparatus 200 via a communication unit 68. Note that the position and orientation of the image capture apparatus 200 may be detected using another known method.

A display control unit 65 renders the virtual space image associated in advance with the position in the real space in accordance with the viewpoint of the image capture apparatus 200, generates the background image of CG in accordance with the angle of view of the image capture apparatus 200, and displays it in the image capture range 310.

The image processing unit 66 detects a region where a specific reflection occurs on the subject 400 as an image capture target that is being captured by the image capture apparatus 200.

A lighting control unit 67 controls the lighting apparatus 500 along an image capture scenario. The lighting control unit 67 controls the lighting apparatus 500 based on the information concerning the lighting state acquired from the lighting apparatus 500 via the communication unit 68.

The communication unit 68 is communicably connected to an external apparatus such as the image capture apparatus 200 or the lighting apparatus 500 via a wire or wirelessly, and exchanges information of data. The communication unit 68 receives the image data and information concerning the operation from the image capture apparatus 200 or the lighting apparatus 500, and supplies them to the position and orientation estimation unit 64, the display control unit 65, the image processing unit 66, and the lighting control unit 67.

### <Control Processing>

Control processing of subject image capture by the system according to the present embodiment will be described next.

FIG. 3 is a flowchart exemplifying control processing of subject image capture by the system according to the present embodiment.

Note that in the following description, the image capture apparatus 200 and the control apparatus 600 will be described as the entities of the processing, but the processing is actually implemented when the control units 21 and 61 of the image capture apparatus 200 and the control apparatus 600 execute programs stored in the nonvolatile memories 22 and 62 to control the respective components of the image capture apparatus 200 and the control apparatus 600, and the lighting apparatus 500.

The processing shown in FIG. 3 is executed in a state in which the image capture apparatus 200 captures an image of the subject 400 as an image capture target in the real space with, as a background, the virtual space image displayed in the image capture range 310 of the display apparatus 300, as shown in FIG. 1.

In step S301, the control apparatus 600 detects a region where a specific reflection occurs on the subject 400 as an image capture target that is being captured by the image capture apparatus 200.

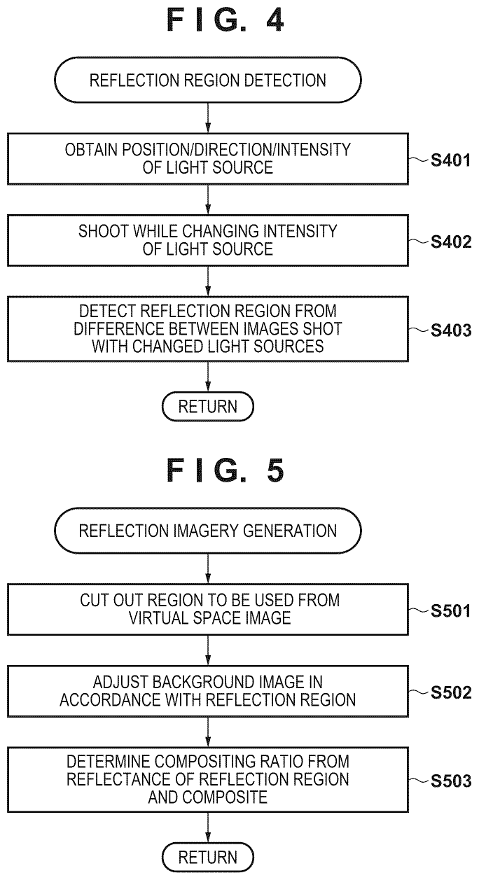

FIG. 4 is a flowchart illustrating the processing of detecting the region where the specific reflection occurs in step S301 of FIG. 3.

The control apparatus 600 performs image capture by changing in advance light emission of the lighting apparatus 500 and the display apparatus 300, thereby detecting a reflection region from the acquired information.

In step S401, the control apparatus 600 acquires in advance the position of the display apparatus 300, and the position, light emission direction, and light emission intensity of the light source of the lighting apparatus 500.

In step S402, the control apparatus 600 causes the image capture apparatus 200 to perform image capture while changing the lighting state while changing the light emission intensity of the light source based on the information of the display apparatus 300 and the lighting apparatus 500 acquired in step S401.

In step S403, the control apparatus 600 detects the region where the specific reflection occurs on the subject 400 as an image capture target based on the image captured in step S402. The specific reflection region is defined as a region where the subject 400 as an image capture target mainly includes the luminance component of an unnecessary subject such as a surrounding object or light source.

In the present embodiment, in a case where it is impossible to express the entire virtual space image due to a narrow display range of the LED wall of the display apparatus 300 used in the virtual production system, a reflection region that is generated when another subject other than the subject 400 as an image capture target is reflected on the subject 400 is detected. When performing image capture by changing the lighting state, the contrast of the subject surface changes in the region where the specific reflection occurs. If, for example, the light emission intensity is increased, a surrounding object or light source is clearly reflected on the subject surface, and thus the contrast increases. On the other hand, if the light emission intensity is decreased, the reflection is reduced, and thus the contrast decreases. In a region where no specific reflection occurs, even if the light emission intensity is changed, the subject surface remains unchanged, and there is not much difference in contrast. Therefore, based on the difference before and after the lighting state is changed, the region where the specific reflection occurs is detected. In the present embodiment, a reflection characteristic (BRDF) is measured by a measurement device with respect to the region where the specific reflection is detected, and the result is used to generate the reflection image. Since the incident angle and the shape of the reflection region are changed by moving the image capture apparatus 200 during the image capture, the reflectance and the shape of the reflection region are prepared for each image capture position in an image capture path controlled by the control apparatus 600.

Referring back to FIG. 3, in step S302, the control apparatus 600 controls the image capture apparatus 200 to capture the image of the subject 400 as an image capture target with, as a background, the virtual space image displayed on the display apparatus 300.

In step S303, the control apparatus 600 determines whether the angle of view of the image capture apparatus 200 that performs image capture in step S302 includes the reflection region detected in step S301. The control apparatus 600 determines whether the reflection region is included in the angle of view by comparing the positions of the specific reflection detected in advance and the reflection region. When the reflection region is included in the angle of view, the process advances to step S304. When the reflection region is not included in the angle of view, the process advances to step S307 without generating the reflection image.

In step S304, the image capture apparatus 200 acquires the position of the image capture apparatus 200 and the position of the reflection region from the control apparatus 600.

In step S305, the image capture apparatus 200 acquires, from the control apparatus 600, the virtual space image displayed on the display apparatus 300.

In step S306, the image capture apparatus 200 generates the reflection image for the reflection region based on the information acquired in steps S304 and S305.

In step S307, the control apparatus 600 determines whether to continue image capture. When image capture is continued, the process returns to step S302, and the next frame is captured. When image capture is not continued, the processing ends.

FIG. 5 is a flowchart illustrating the processing of generating the reflection image in step S306 of FIG. 3.

The image capture apparatus 200 generates the reflection image by cutting out and compositing the virtual space image acquired from the control apparatus 600 in accordance with the reflection region in the angle of view of the image capture apparatus 200.

In step S501, the image capture apparatus 200 cuts out, from the virtual space image, a region necessary to generate the reflection image. In accordance with the position and image capture angle of the image capture apparatus 200 and the position of the reflection region, the image capture apparatus 200 cuts out, from the virtual space image, a region to be used to generate the reflection image. The image capture apparatus 200 associates the position of the reflection region with the coordinate position in the virtual space image, and renders, from the virtual space image around the coordinate position of the reflection region, an image of a subject that may be reflected on the subject 400 as an image capture target, thereby generating a background image of CG for the reflection image.

In step S502, in accordance with the size and shape of the reflection region, the image capture apparatus 200 adjusts the background image generated in step S501. To composite the background image and the reflection region in subsequent processing, deformation processing is performed for the background image in accordance with the shape and size of the reflection region and the image capture angle of the image capture apparatus 200.

In step S503, the image capture apparatus 200 composites the background image adjusted in step S502 into the reflection region in accordance with the reflectance of the reflection region. In the present embodiment, it is possible to generate the image of the subject 400 as an image capture target applied with a desired reflection by compositing the background image into the reflection region based on the reflectance of the reflection region calculated in advance. As the reflectance used in the present embodiment, the reflectance measured in step S403 is used.

In the present embodiment, the reflection region is detected by changing the lighting state, but may be detected by changing the degree of polarization. For example, a polarizing element is attached in front of the image capture apparatus 200 or the lens, and detection is performed using a plurality of polarized images captured while changing the polarization direction of the polarizing element. The detection target in this case is light acquired when the luminance component of an unnecessary subject such as a surrounding object or light source is reflected specularly. The light specularly reflected by the surface of the subject has a high degree of polarization, and changes in luminance in accordance with the direction of the polarizing element. On the other hand, the subject that is not reflected has constant luminance regardless of the direction of the polarizing element. By using this difference, a region where the luminance changes can be detected as a region where the specific reflection occurs.

Furthermore, in the present embodiment, when detecting a reflection region, the reflectance and the shape of the reflection region are prepared in advance for each image capture position in the image capture path. However, a region where the specific reflection occurs may be modeled in advance to generate a 3D model. For example, a 3D model is generated by image capture, from various angles, the subject 400 on which the specific reflection occurs while specifying the region where the specific reflection occurs, and they are recorded in association with each other. Then, by using the associated information of the reflection region in accordance with the angle at which the subject 400 is captured during the image capture, it is possible to determine whether the reflection region is included in the angle of view of the image capture apparatus 200, and the shape of the reflection region is used to adjust the background image.

The present embodiment has explained an example of measuring the reflectance using the measurement device. However, the irradiation direction of the lighting apparatus 500 used during the image capture may be changed and the reflectance of the reflection region may be measured based on the angle of incident light on the subject 400. The reflectance depends on polarization, light in the polarization direction perpendicular to the incident surface is an S-wave (S-polarized light), and light in the polarization direction parallel to the incident surface is a P-wave (P-polarized light). Reflectances Rs and Rp can be calculated by:

$${R}_{s} = {( \frac{cos α - \sqrt{{n}^{2} - {sin}^{2} α}}{cos α + \sqrt{{n}^{2} - {sin}^{2} α}} )}^{2} \qquad ( 1 )$$

$${R}_{p} = {( \frac{{n}^{2} cos α - \sqrt{{n}^{2} - {sin}^{2} α}}{{n}^{2} cos α + \sqrt{{n}^{2} - {sin}^{2} α}} )}^{2} \qquad ( 2 )$$

where n represents a relative refractive index and is assumed to be 1.5 to 1.6 in the present embodiment, and a represents an incident angle. The incident angle α is calculated using a normal vector. The normal vector is calculated by photometric stereo using a plurality of images captured while changing the position of the lighting apparatus 500.

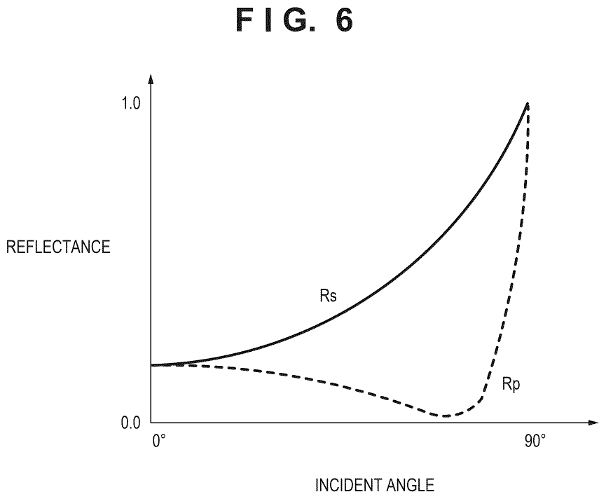

FIG. 6 exemplifies the reflectance corresponding to the incident angle α of the reflection region. The abscissa represents the incident angle and the ordinate represents the reflectances Rs and Rp. In the example shown in FIG. 6, since the reflectance of the S-wave (S-polarized light) is higher than the reflectance of the P-wave at any incident angle, the reflectance Rs of the S-wave is calculated and used to generate the reflection image in the present embodiment.

In the present embodiment, in the processing of generating the reflection image in FIG. 5, the virtual space image is rendered to generate the reflection image. However, the reflection image may be generated using Image Based Lighting based on the reflection characteristic (BRDF), the normal vector of the subject, the virtual space image, and the viewpoint position of the image capture apparatus 200.

Furthermore, in the present embodiment, in the processing of generating the reflection image in FIG. 5, the virtual space image is rendered to generate the reflection image. However, the reflection image may be generated by performing machine learning such as deep learning using a model learned in advance. For example, a learning model is learned using, as supervisory data, the image without the specific reflection and the image in which the specific reflection occurs with the virtual space image as a background, thereby generating a learned model. Then, inference processing is performed using the learned model by inputting the image captured by the image capture apparatus 200, thereby generating the reflection image. This can generate a natural reflection image in an image capture scene with the virtual space image as a background.

The learned model according to the present embodiment is formed by a neural network, and is formed by a Convolutional Neural Network (CNN) in the present embodiment. Note that an inference model according to the present embodiment is not limited to the CNN, and may be formed by a neural network such as a transformer.

The inference processing according to the present embodiment can be executed by a Graphics Processing Unit (GPU) or a Digital Signal Processor (DSP). The GPU or DSP is a processor capable of performing an enormous amount of product-sum operations, bias addition operations, and nonlinear processing, and has arithmetic processing capability of performing a matrix operation of a neural network and the like within a short time. Note that in the inference processing, the CPU of the control unit 21 and the GPU or DSP of the image processing unit 26 may perform arithmetic processing in cooperation with each other or one of the CPU of the control unit 21 and the GPU or DSP of the image processing unit 26 may perform arithmetic processing.

In the present embodiment, the image capture apparatus 200 and the control apparatus 600 share the processing, that is, the control apparatus 600 performs the processing of detecting the reflection region and the image capture apparatus 200 performs the processing of generating the reflection image. However, the image capture apparatus 200 or the control apparatus 600 may serve as an image processing apparatus to perform the processing of detecting the reflection region and the processing of generating the reflection image.

As described above, according to the present embodiment, in virtual production, in a case where the specific reflection occurs on the subject as an image capture target, such as a case where the background to be reflected is broken or a necessary region is not reflected due to a narrow display range of the LED wall or a case where illumination light is reflected when controlling the brightness of the illumination light on a person or the like, it is possible to generate the desired reflection image using the virtual space image for the region where the specific reflection occurs.

Note that the processing of generating the reflection image is performed in the present embodiment, but processing of removing a specific reflection may be added.

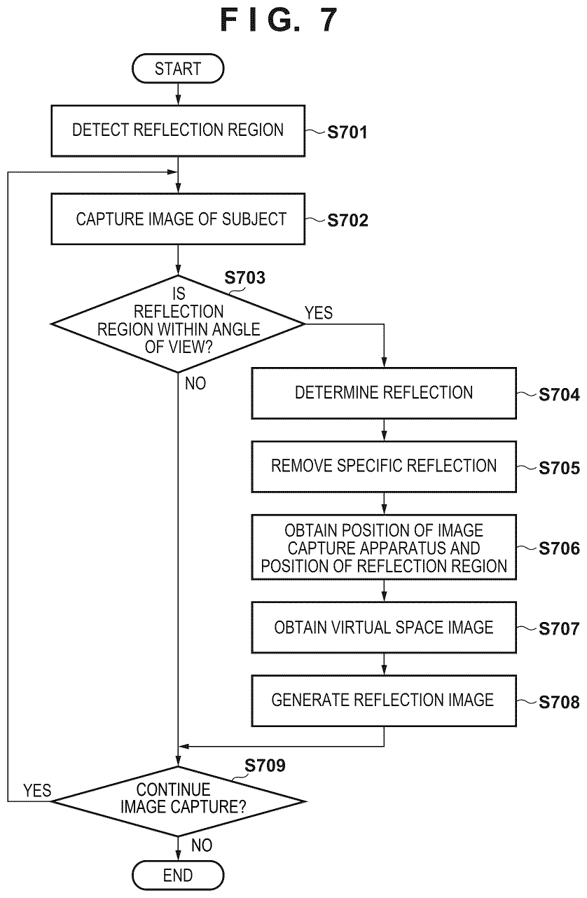

FIG. 7 exemplifies a flowchart in which processing of removing a specific reflection is added to the processing shown in FIG. 3. In the processing shown in FIG. 7, processing of determining a specific reflection in step S704 and processing of removing the specific reflection in step S705 are added to the processing shown in FIG. 3. Steps S701 to S703 and S706 to S709 of FIG. 7 are the same as steps S301 to S307 of FIG. 3.

As the difference from the processing shown in FIG. 3, the processing of determining a specific reflection in step S704 and the processing of removing the specific reflection in step S705 in FIG. 7 will be described below.

In step S704, the control apparatus 600 detects in advance the difference between the reflection region of the subject 400 as an image capture target in a state in which the lighting apparatus 500 is not lighted and the reflection region during the image capture, and when the difference is larger than a threshold, the region is determined as a region where a specific reflection occurs and is set as a removing target.

In step S705, the control apparatus 600 performs removal processing for the reflection region set as a removing target in step S704 so as to eliminate the specific reflection. For example, the image is adjusted to the lighting state during the image capture using the image without the specific reflection that has been captured when detecting the reflection region in advance, and is composited into the reflection region, thereby removing the specific reflection.

In the present embodiment, the specific reflection is removed using the image without the specific reflection which has been captured in advance, but the present disclosure is not limited to this. For example, if image capture is performed by a plurality of image capture apparatuses in addition to the image capture apparatus 200, the image with the least specific reflection may be selected from images captured by the image capture apparatuses with the angles of view different from that of the image capture apparatus 200, and the reflection region may be composited into the selected image, thereby removing the specific reflection. As another method, the image of the subject without the specific reflection is generated by performing learning using the image acquired by capturing the image of the subject 400 in advance, and a region without the specific reflection is composited with the reflection region. In this method, a learned model is generated by performing learning using images of a plurality of viewpoints acquired by image capture in advance the subject 400 at various angles, the image of the subject 400 without the specific reflection is generated using the learned model in accordance with the direction, angle, and size of the subject 400 corresponding to the actual image capture angle, and the reflection region is then replaced with the generated image.

The present embodiment has explained the processing of generating the reflection image. However, the specific reflection may be easily removed by changing, to the image from which the specific reflection is easily detected, an image of a region except for the image capture range 310 of the display apparatus 300, that is, the region of the display apparatus 300 that is not used for image capture. In a case where, for example, various unnecessary subjects are reflected in a reflection region, it is necessary to remove the subjects reflecting light beams of different frequencies. In a case where another subject to be captured exists in the real space in addition to the subject 400, and the other subject is reflected on the subject 400, it is difficult to distinguish whether the reflection is a specific reflection. To cope with this, by irradiating the region except for the image capture range 310 of the display apparatus 300 with single-frequency light, it becomes easier to distinguish between the subject as an image capture target and the other subject, and it is possible to remove only the specific reflection.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2025-020987, filed Feb. 12, 2025 which is hereby incorporated by reference herein in its entirety.

What is claimed is:

1. An image processing apparatus comprising:
at least one processor; and
at least one memory which stores a program which, when executed by the at least one processor, causes the image processing apparatus to function as:
a display control unit that displays a virtual space image on a display apparatus provided in a real space; and
a generation unit that generates, for a reflection region where a specific reflection occurs on a subject in an image acquired by capturing an image of the subject in the real space and the virtual space image displayed on the display apparatus, a reflection image corresponding to the reflection region based on a position of the reflection region, a position at which the image is captured, and the virtual space image.

2. The apparatus according to claim 1, wherein the at least one processor functions as an acquisition unit that acquires the image by image capture, by an image capture apparatus, the subject in the real space and the virtual space image displayed on the display apparatus.

3. The apparatus according to claim 2, wherein the generation unit generates the reflection image by cutting out the virtual space image in accordance with the reflection region within an angle of view of the image capture apparatus, and compositing the cut out image and the reflection region.

4. The apparatus according to claim 3, wherein the generation unit generates the reflection image by acquiring a reflectance of the reflection region based on an image captured by changing at least one of a position and a lighting state of a lighting apparatus provided in the real space and the display apparatus, and compositing the cut out image and the reflection region based on the reflectance.

5. The apparatus according to claim 1, wherein the generation unit generates the reflection image using a learned model acquired by performing learning using the image without the specific reflection which has been captured in advance and the image with the specific reflection which has been captured with the virtual space image as a background.

6. The apparatus according to claim 2, wherein the at least one processor functions as a detection unit that detects a region where the specific reflection occurs from the image captured by the image capture apparatus.

7. The apparatus according to claim 6, wherein the detection unit detects the reflection region based on an image captured by changing at least one of a position and a lighting state of a lighting apparatus provided in the real space and the display apparatus.

8. The apparatus according to claim 7, wherein the lighting state of the lighting apparatus includes at least one of the presence/absence of lighting of a light source, an irradiation direction, a light emission intensity, and a color temperature.

9. The apparatus according to claim 6, wherein the at least one processor functions as a removing unit that removes the specific reflection with respect to the reflection region detected by the detection unit.

10. The apparatus according to claim 9, wherein the removing unit removes the specific reflection by compositing, into the reflection region, the image without the specific reflection which has been captured in advance.

11. The apparatus according to claim 9, wherein the removing unit removes the specific reflection by selecting the image with the least reflection from images captured by image capture apparatuses with angles of view different from an angle of view of the image capture apparatus, and compositing the selected image with the reflection region.

12. The apparatus according to claim 9, wherein the removing unit removes the specific reflection by generating the image without the specific reflection by performing learning using the image of the subject which has been captured in advance, and compositing the generated image with the reflection region.

13. The apparatus according to claim 2, wherein the display control unit controls to display, in a region of the display apparatus that is not included in an angle of view of the image capture apparatus, an image for detecting the specific reflection.

14. An image processing method executed by an image processing apparatus comprising:
displaying a virtual space image on a display apparatus provided in a real space; and
generating, for a reflection region where a specific reflection occurs on a subject in an image acquired by capturing an image of the subject in the real space and the virtual space image displayed on the display apparatus, a reflection image corresponding to the reflection region based on a position of the reflection region, a position at which the image is captured, and the virtual space image.

15. A non-transitory computer-readable storage medium storing a program for causing a computer to function as an image processing apparatus comprising:
a display control unit that displays a virtual space image on a display apparatus provided in a real space; and
a generation unit that generates, for a reflection region where a specific reflection occurs on a subject in an image acquired by capturing an image of the subject in the real space and the virtual space image displayed on the display apparatus, a reflection image corresponding to the reflection region based on a position of the reflection region, a position at which the image is captured, and the virtual space image.

16. A system including an image capture apparatus and a control apparatus,
wherein the control apparatus comprises
at least one processor, and
at least one memory which stores a program which, when executed by the at least one processor, causes the control apparatus to function as:
a display control unit that displays a virtual space image on a display apparatus provided in a real space; and
a detection unit that detects a reflection region where a specific reflection occurs on a subject in an image acquired by capturing an image of the subject in the real space and the virtual space image displayed on the display apparatus, and
wherein the image capture apparatus comprises
an imaging unit that captures the subject in the real space and the virtual space image displayed on the display apparatus,
at least one processor, and
at least one memory which stores a program which, when executed by the at least one processor, causes the image capture apparatus to function as:
a generation unit that generates, for the reflection region in an image acquired by the imaging unit, a reflection image corresponding to the reflection region based on a position of the reflection region, a position at which the image is captured, and the virtual space image.
